(19) United States
(12) Patent Application Publication
(10) Pub. No.: US 2026/0066992 A1
(43) Pub. Date: Mar. 5, 2026

(54) OPTICAL SIGNAL MODIFIER, LIDAR TESTER COMPRISING SUCH A MODIFIER, AND CORRESPONDING METHOD WITH CONTRAST ENHANCEMENT

(71) Applicant: Rohde & Schwarz GmbH & Co. KG, Munich (DE)

(72) Inventors: Moritz UEFFING, Munich (DE); Maximilian FINK, Munich (DE); Benedikt SIMPER, Buch am Erlbach (DE)

(73) Assignee: Rohde & Schwarz GmbH & Co. KG, Munich (DE)

(21) Appl. No.: 18/821,442

(22) Filed: Aug. 30, 2024

(51) Int. Cl. H04B 10/50; H01S 3/067; H04B 10/508

(52) U.S. Cl. CPC H04B 10/503; H01S 3/06754; H04B 10/508

(57) ABSTRACT

An optical signal modifier for providing an amplified pulsed optical signal is provided. Said optical signal modifier comprises an optical time-domain filter arranged for filtering an optical signal amplified by an amplifier of the optical signal modifier. In this context, the optical signal modifier is configured to determine the corresponding time of the respective pulse and/or the corresponding location of the respective pulse. In addition to this, the optical signal modifier is configured to trigger the optical time-domain filter in accordance with said corresponding time and/or location of the respective pulse such that any signal outside said pulse is suppressed by the optical time-domain filter.

### TECHNICAL FIELD

The present disclosure relates to an optical signal modifier, a Lidar (Light detection and ranging) tester comprising such a modifier, and a corresponding method with contrast enhancement. In particular, the present disclosure relates to an optical signal modifier for providing an amplified pulsed optical signal, a Lidar tester for testing a Lidar device under test or a Lidar sensor, said Lidar tester comprising such an optical signal modifier, and a method for removing unwanted background from an amplified pulsed optical signal.

### BACKGROUND ART

In times of an increasing number of Lidar sensors, exemplarily used in the context of autonomous driving, there is a growing need of an optical signal modifier, a Lidar tester comprising such a modifier, and a corresponding method with contrast enhancement for verifying correct functioning of such Lidar sensor in a particularly accurate and efficient manner.

For instance, document JPS 6173051 A discloses a testing device for an optical fiber. The purpose of said testing device is to remove noises and to improve a signal-to-noise ratio by providing a wavelength selective filter to an optical path which extends from a light source to a photodetecting element.

Disadvantageously, such a configuration based on a wavelength selective filter cannot provide a particularly efficient contrast enhancement or manipulation of the corresponding return signal in the sense of intensity, especially in the sense of temporal contrast, respectively.

### SUMMARY

Thus, there is a need to provide a correspondingly improved optical signal modifier, Lidar tester, and method.

This is achieved by the embodiments provided in the enclosed independent claims. Advantageous implementations of the present disclosure are further defined in the dependent claims.

According to a first aspect of the present disclosure, an optical signal modifier for providing an amplified pulsed optical signal is provided. Said optical signal modifier comprises an optical time-domain filter arranged for filtering an optical signal amplified by an amplifier of the optical signal modifier. In this context, the optical signal modifier is configured to determine the corresponding time of the respective pulse and/or the corresponding location of the respective pulse. In addition to this, the optical signal modifier is configured to trigger the optical time-domain filter in accordance with said corresponding time and/or location of the respective pulse such that any signal outside said pulse is suppressed by the optical time-domain filter.

Advantageously, contrast enhancement with respect to the optical signal can be achieved in a particularly efficient manner. Further advantageously, manipulation of a degree of freedom in the sense of intensity, especially temporal contrast, of said optical signal can efficiently be achieved.

According to an implementation form of the first aspect of the present disclosure, the optical time-domain filter comprises or is an electro-optical switch, an electro-optical switch with a trigger, an acousto-optical switch, an acousto-optical switch with a trigger, or any combination thereof. Advantageously, for instance, complexity can be reduced, thereby increasing efficiency.

According to an implementation form of the first aspect of the present disclosure, the optical signal modifier further comprises an optical frequency filter. In this context, the optical signal modifier is configured to determine the corresponding frequency of the respective pulse, especially for the case that said corresponding frequency of the respective pulse is not known. In addition to this, the optical signal modifier is configured to trigger the optical frequency filter in accordance with said corresponding frequency of the respective pulse. Advantageously, for example, the corresponding noise floor in regions that are not covered by the signal spectral bandwidth can efficiently be suppressed.

According to an implementation form of the first aspect of the present disclosure, the optical signal modifier further comprises an optical amplifier. In this context, the optical time-domain filter comprises or is pulsed pumping of said optical amplifier. Advantageously, for instance, the optical signal can further be increased, thereby further improving contrast. Further advantageously, an inversion window of the amplifier matches the corresponding signal, thereby further reducing amplified spontaneous emission.

According to an implementation form of the first aspect of the present disclosure, the optical amplifier comprises or is a laser amplifier. Advantageously, for example, inefficiencies can further be reduced.

According to an implementation form of the first aspect of the present disclosure, the optical time-domain filter comprises or is a non-linear optical contrast enhancement. Advantageously, for instance, efficiency can further be increased.

According to an implementation form of the first aspect of the present disclosure, the optical signal modifier further comprises a non-linear optical amplifier. In this context, the non-linear optical amplifier is configured to use a pulsed optical power source, especially to window the corresponding time of amplification. Advantageously, for example, the optical signal can further be increased, thereby further enhancing contrast.

According to an implementation form of the first aspect of the present disclosure, the non-linear optical amplifier comprises or is an optical parametric amplifier or a Raman amplifier. Advantageously, for instance, complexity can be reduced, thereby increasing efficiency.

According to an implementation form of the first aspect of the present disclosure, the optical signal modifier is configured to apply cross-phase mixing, especially to reduce corresponding noise. Advantageously, for example, inefficiencies can further be reduced.

According to an implementation form of the first aspect of the present disclosure, the optical time-domain filter comprises or is a shutter or a mechanical shutter. Advantageously, for instance, the optical time-domain filter can be implemented in a particularly cost-efficient manner.

According to an implementation form of the first aspect of the present disclosure, the optical time-domain filter is triggered in accordance with the corresponding time and/or location of the respective pulse to remove unwanted background from the amplified pulsed optical signal. Advantageously, for example, contrast can further be enhanced in a particularly efficient manner.

According to a second aspect of the present disclosure, a Lidar tester for testing a Lidar device under test or a Lidar sensor is provided. Said Lidar tester comprises an optical signal modifier according to the first aspect of the present disclosure or any of its implementation forms, respectively, especially configured to emit an amplified pulsed optical signal towards the Lidar device under test or towards the Lidar sensor.

Advantageously, contrast enhancement with respect to the optical signal can be achieved in a particularly efficient manner. Further advantageously, manipulation of a degree of freedom in the sense of intensity, especially temporal contrast, of the corresponding return signal can efficiently be achieved.

According to a third aspect of the present disclosure, a method for removing unwanted background from an amplified pulsed optical signal is provided. Said method comprises the steps of determining the corresponding time of the respective pulse of said amplified pulsed optical signal and/or the corresponding location of the respective pulse of said amplified pulsed optical signal, providing an optical time-domain filter, especially arranged for filtering an optical signal amplified by an amplifier of an optical signal modifier, and triggering the optical time-domain filter in accordance with said corresponding time and/or location of the respective pulse of said amplified pulsed optical signal such that any signal outside said pulse is suppressed by the optical time-domain filter.

Advantageously, contrast enhancement with respect to the optical signal can be achieved in a particularly efficient manner. Further advantageously, manipulation of a degree of freedom in the sense of intensity, especially temporal contrast, of said optical signal can efficiently be achieved.

According to an implementation form of the third aspect of the present disclosure, the optical time-domain filter comprises or is an electro-optical switch, an electro-optical switch with a trigger, an acousto-optical switch, an acousto-optical switch with a trigger, or any combination thereof. Advantageously, for instance, complexity can be reduced, thereby increasing efficiency.

According to an implementation form of the third aspect of the present disclosure, the method further comprises the steps of providing an optical frequency filter, determining the corresponding frequency of the respective pulse of the amplified pulsed optical signal, especially for the case that said corresponding frequency of the respective pulse of the amplified pulsed optical signal is not known, and triggering the optical frequency filter in accordance with said corresponding frequency of the respective pulse of the amplified pulsed optical signal. Advantageously, for example, the corresponding noise floor in regions that are not covered by the signal spectral bandwidth can efficiently be suppressed.

According to an implementation form of the third aspect of the present disclosure, the optical time-domain filter comprises or is pulsed pumping of an optical amplifier. Advantageously, for instance, the optical signal can further be increased, thereby further improving contrast.

According to an implementation form of the third aspect of the present disclosure, the optical amplifier comprises or is a laser amplifier. Advantageously, for example, inefficiencies can further be reduced.

According to an implementation form of the third aspect of the present disclosure, the optical time-domain filter comprises or is a non-linear optical contrast enhancement. Advantageously, for instance, efficiency can further be increased.

According to an implementation form of the third aspect of the present disclosure, the method further comprises the steps of using a non-linear optical amplifier for generating the amplified pulsed optical signal, and using a pulsed optical power source with the aid of said non-linear optical amplifier, especially to window the corresponding time of amplification. Advantageously, for example, the optical signal can further be increased, thereby further enhancing contrast.

According to an implementation form of the third aspect of the present disclosure, the non-linear optical amplifier comprises or is an optical parametric amplifier or a Raman amplifier. Advantageously, for instance, complexity can be reduced, thereby increasing efficiency.

The above description with regard to the optical signal modifier and the Lidar tester according to the first and second aspects of the disclosure is correspondingly valid for the method according to the third aspect of the disclosure, and vice versa.

### BRIEF DESCRIPTION OF THE DRAWINGS

The above-described aspects and implementation forms of the present disclosure will be explained in the following description of specific embodiments in relation to the enclosed drawings, in which:

FIG. 1 shows a block diagram of an exemplary embodiment of an optical signal modifier;

FIG. 2 shows a block diagram of a further exemplary embodiment of an optical signal modifier;

FIG. 3 shows a block diagram of a further exemplary embodiment of an optical signal modifier;

FIG. 4A illustrates time-domain filtering;

FIG. 4B illustrates frequency-domain filtering;

FIG. 5 shows a block diagram of an exemplary embodiment of a Lidar tester;

FIG. 6 shows a flow diagram of an exemplary embodiment of a method for removing unwanted background from an amplified pulsed optical signal;

FIG. 7 shows a flow diagram of a further exemplary embodiment of a method for removing unwanted background from an amplified pulsed optical signal; and

FIG. 8 shows a flow diagram of a further exemplary embodiment of a method for removing unwanted background from an amplified pulsed optical signal.

### DETAILED DESCRIPTIONS OF EMBODIMENTS

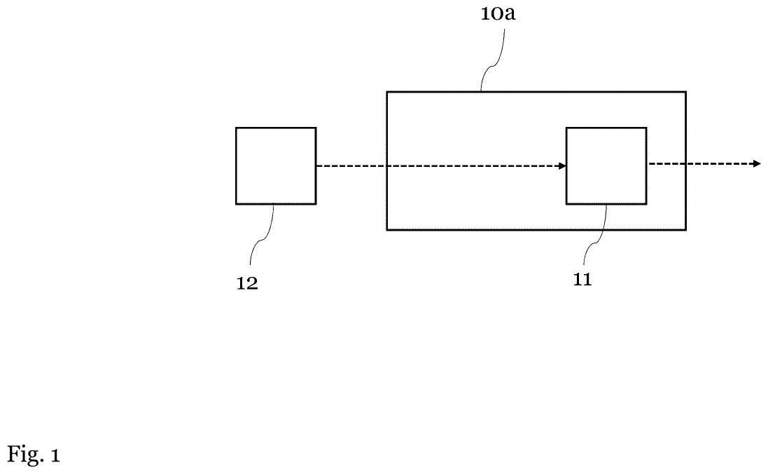

FIG. 1 illustrates a block diagram of an exemplary embodiment of an optical signal modifier 10a for providing an amplified pulsed optical signal. Said optical signal modifier 10a comprises an optical time-domain filter 11 arranged for filtering an optical signal amplified by an amplifier 12, especially by an optical amplifier, of the optical signal modifier 10a. In this context, the optical signal modifier 10a is configured to determine the corresponding time of the respective pulse and/or the corresponding location of the respective pulse. In addition to this, the optical signal modifier 10a is configured to trigger the optical time-domain filter 11 in accordance with said corresponding time and/or location of the respective pulse such that any signal outside said pulse is suppressed by the optical time-domain filter 11.

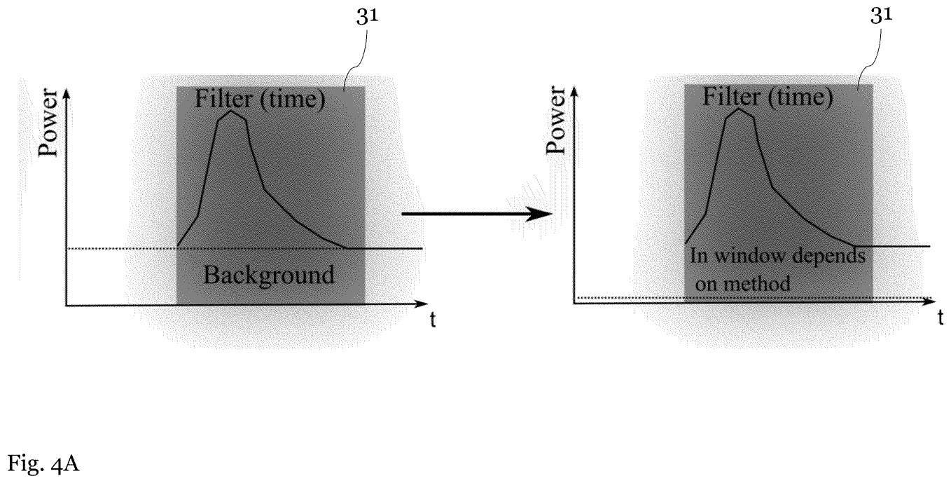

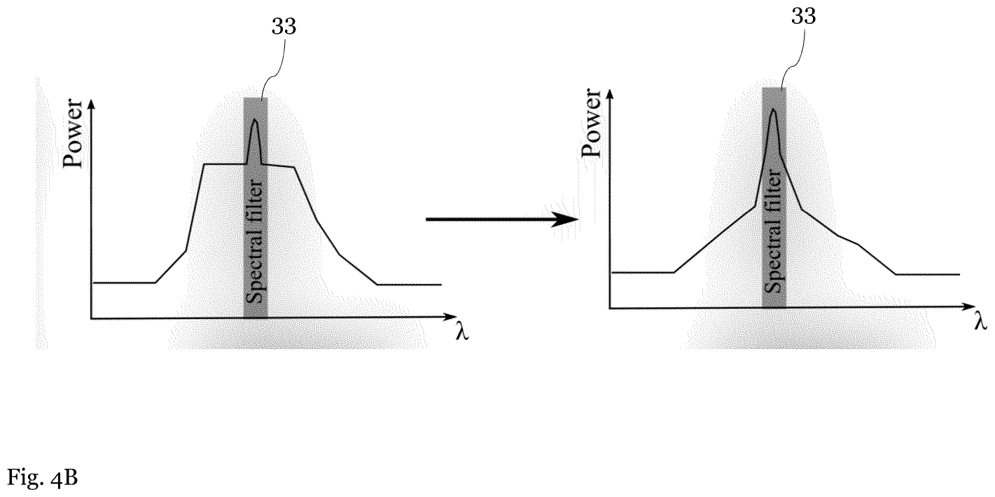

It is noted that FIG. 4A exemplarily depicts such a time-domain filtering. As it can be seen from an exemplary time-power diagram according to said FIG. 4A, a filtering window 31 is aligned with the respective pulse of the corresponding amplified pulsed optical signal, thereby especially suppressing background.

Again, with respect to the optical signal modifier 10a according to FIG. 1, it is noted that it might be particularly advantageous if the optical time-domain filter 11 comprises or is an electro-optical switch, an electro-optical switch with a trigger, an acousto-optical switch, an acousto-optical switch with a trigger, or any combination thereof. It is further noted that the optical time-domain filter 11 can also comprise or be an optical switch, a mechanical switch, a non-linear optical switch, an acousto-optic modulator, a Bragg cell, or any combination thereof.

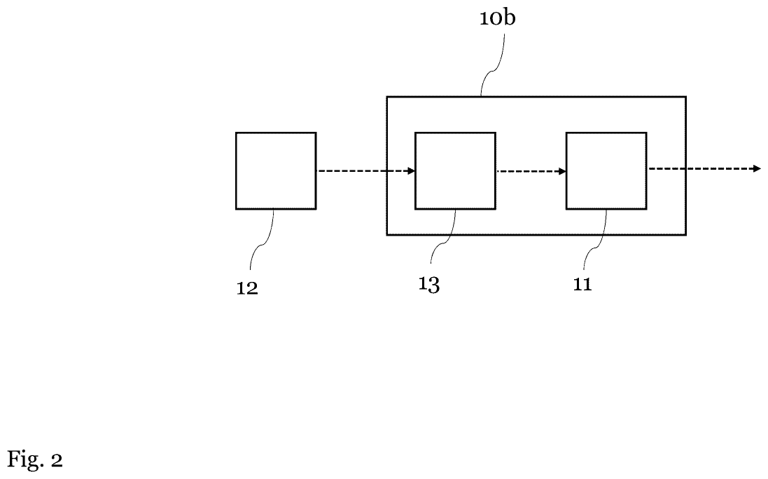

Now, with respect to FIG. 2, a block diagram of a further exemplary embodiment of an optical signal modifier 10b for providing an amplified pulsed optical signal is shown. Said optical signal modifier 10b is based on the one 10a according to FIG. 1 with the difference that the optical signal modifier 10b further comprises an optical frequency filter 13. In this context, the optical signal modifier 10b is configured to determine the corresponding frequency of the respective pulse, especially for the case that said corresponding frequency of the respective pulse is not known. In addition to this, the optical signal modifier 10b is configured to trigger the optical frequency filter 13 in accordance with said corresponding frequency of the respective pulse.

It is noted that FIG. 4B exemplarily depicts such a frequency-domain filtering. As it can be seen from an exemplary wavelength-power diagram according to said FIG. 4B, a filtering window 33, exemplarily a spectral filter, is aligned with the respective pulse of the corresponding amplified pulsed optical signal, thereby especially suppressing correspondingly unwanted signal portions.

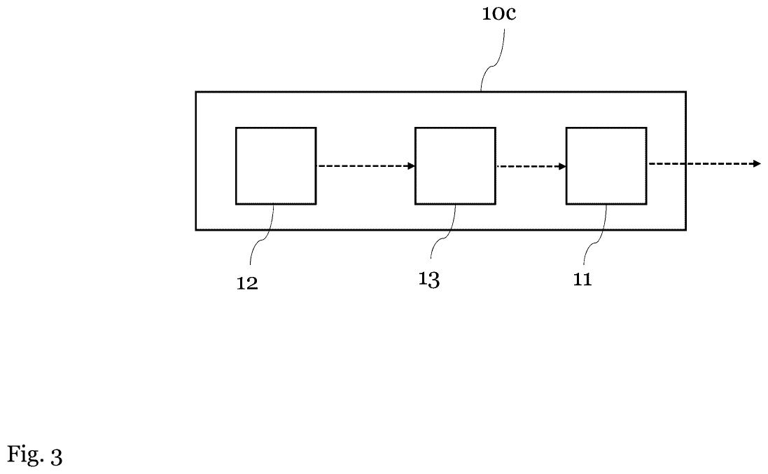

It is further noted that it might be particularly advantageous if the optical signal modifier 10b further comprises an optical amplifier, which can analogously apply for the optical signal modifier 10a of FIG. 1. For instance, in accordance with FIG. 3 illustrating a block diagram of a further exemplary embodiment of an optical signal modifier 10c for providing an amplified pulsed optical signal, based on the one 10b according to FIG. 2, said optical signal modifier 10c comprises the amplifier 12, wherein the optical time-domain filter 11 comprises or is pulsed pumping of said amplifier 12 or optical amplifier, respectively.

In this context, it is noted that it might be particularly advantageous if the amplifier 12 or optical amplifier, respectively, comprises or is a laser amplifier.

With respect to the optical time-domain filter 11, it is noted that it might be particularly advantageous if the optical time-domain filter 11 comprises or is a non-linear optical contrast enhancement.

It is further noted that it might be particularly advantageous if the optical signal modifier 10c or 10b or 10a, respectively, further comprises a non-linear optical amplifier, wherein the non-linear optical amplifier is configured to use a pulsed optical power source, especially to window the corresponding time of amplification. For instance, the amplifier 12 could be such a non-linear optical amplifier.

In this context, it is noted that it might be particularly advantageous if the non-linear optical amplifier comprises or is an optical parametric amplifier or a Raman amplifier.

Furthermore, it is noted that it might be particularly advantageous if the optical signal modifier 10c or 10b or 10c, respectively, is configured to apply cross-phase mixing, especially to reduce corresponding noise.

Again, with respect to the optical time-domain filter 11, it is noted that it might be particularly advantageous if the optical time-domain filter 11 comprises or is a shutter or a mechanical shutter.

Moreover, it might be particularly advantageous if the optical time-domain filter 11 is triggered in accordance with the corresponding time and/or location of the respective pulse to remove unwanted background from the amplified pulsed optical signal.

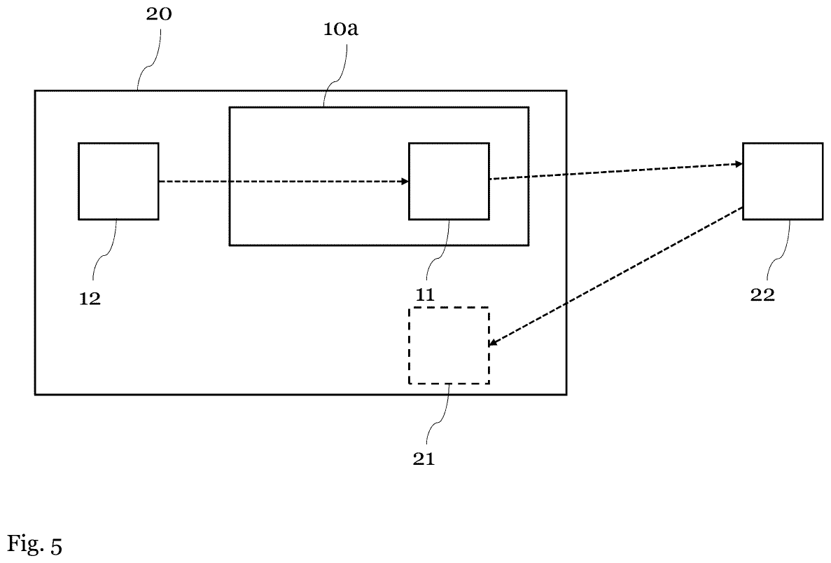

Now, with respect to FIG. 5, a block diagram of an exemplary embodiment of a Lidar (Light detection and ranging) tester 20 for testing a Lidar device under test or a Lidar sensor 22 is illustrated. Said Lidar tester 20 comprises the optical signal modifier 10a and the amplifier according to FIG. 1. Exemplarily, the Lidar tester 20 is configured to emit an amplified pulsed optical signal towards the Lidar device under test or towards the Lidar sensor 22. It is noted that the optical signal modifier 10a could be replaced by the optical signal modifier 10b of FIG. 2 or by the optical signal modifier 10c of FIG. 3, respectively.

As it can further be seen from FIG. 5, the Lidar tester 20 can further comprise an optical signal sink 21 for receiving a corresponding signal from the Lidar device under test or the Lidar sensor 22.

Advantageously, the Lidar tester 20 can be configured to manipulate the signal sent out by the Lidar device under test or by the Lidar sensor 22 in the purely optical domain. Accordingly, no electro-optical or opto-electrical conversion is involved. In the case of high insertion losses in the Lidar tester 20, optical amplification of the corresponding signal might be necessary, especially with the aid of the amplifier 12. For instance, optical amplification can be achieved with the aid of an erbium-doped fiber-amplifier, a semiconductor optical amplifier, a booster optical amplifier, or any combination thereof. Accordingly, the amplifier 12 could be such an amplifier. Typically, said optical amplification introduces an unwanted background seen by the Lidar device under test or the Lidar sensor 22 especially due to (amplified) spontaneous emission.

For continuously pumped optical amplifiers the background is also continuous. Depending on the amplifier design the spectrum of the (amplified) spontaneous emission might also be larger than the spectral bandwidth of the signal.

Advantageously, especially in the light of the description above regarding the different embodiments 10a, 10b, 10c of the optical signal modifier, the Lidar tester 20 can provide temporal filtering or spectral and temporal filtering, respectively, of the amplified signal to suppress the noise floor caused by the amplifier(s), such as the amplifier 12, in the Lidar tester 20.

Further advantageously, cutting the signal in the spectral domain, as exemplarily illustrated by FIG. 4B, helps to suppress the noise floor in regions that are not covered by the signal spectral bandwidth. However, the contrast of the signal (relative to the background) remains unchanged in the regions the spectral filter is “open”.

As a further advantage, temporal contrast enhancement, as exemplarily illustrated by FIG. 4A, improves the situation especially if a pulsed input signal (signal from the Lidar device under test or Lidar sensor 22) is selected in the time domain. The continuous optical background can be removed for all times except for the time window the input signal needs to pass through the system.

As indicated above, especially to increase the signal of the Lidar tester 20, temporal filtering can exemplarily be implemented as follows:
Temporal filtering of the amplified laser pulse using an optical switch, a mechanical switch, a non-linear optical switch, an electro-optical switch, an acousto-optical switch, an acousto-optic modulator, or any combination thereof.
Pulsed pumping of the laser amplifier.
Non-linear optical contrast enhancement.
Implementing a non-linear optical amplifier, especially an optical parametric amplifier and/or a Raman amplifier, using a pulsed optical power source to window the corresponding time of amplification.

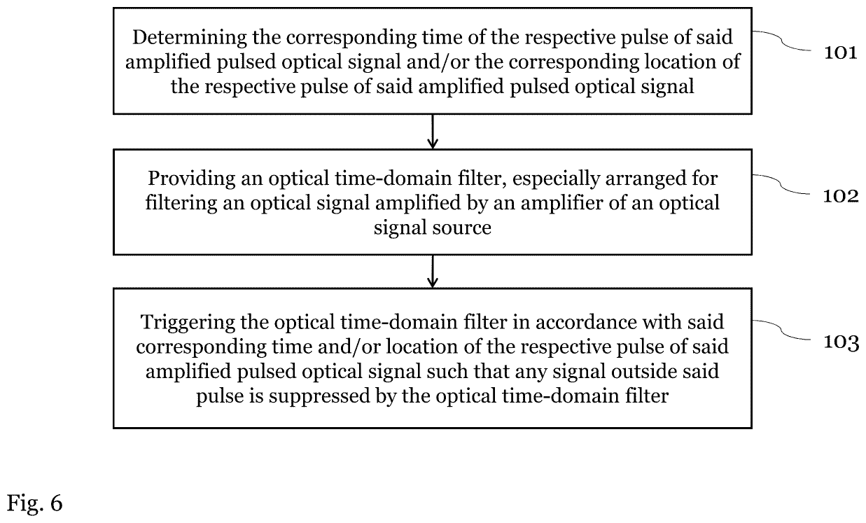

Now, with respect to FIG. 6, a flow diagram of an exemplary embodiment of a method for removing unwanted background from an amplified pulsed optical signal is illustrated. Exemplarily, a step 101 comprises determining the corresponding time of the respective pulse of said amplified pulsed optical signal and/or the corresponding location of the respective pulse of said amplified pulsed optical signal. A further step 102 comprises providing an optical time-domain filter, such as the optical time-domain filter 11 described above, especially arranged for filtering an optical signal amplified by an amplifier of an optical signal modifier, such as the amplifier 12 of one of the optical signal modifiers 10a, 10b, 10c described above. Another step 103 comprises triggering the optical time-domain filter in accordance with said corresponding time and/or location of the respective pulse of said amplified pulsed optical signal such that any signal outside said pulse is suppressed by the optical time-domain filter.

With respect to the optical time-domain filter, it is noted that it might be particularly advantageous if the optical time-domain filter comprises or is an electro-optical switch, an electro-optical switch with a trigger, an acousto-optical switch, an acousto-optical switch with a trigger, or any combination thereof.

Furthermore, all the explanations above regarding the optical signal modifier and regarding the optical time-domain filter or the corresponding related elements, respectively, can analogously apply to the corresponding elements of the method, and vice versa. In addition, this can analogously apply to the Lidar tester described above, and vice versa.

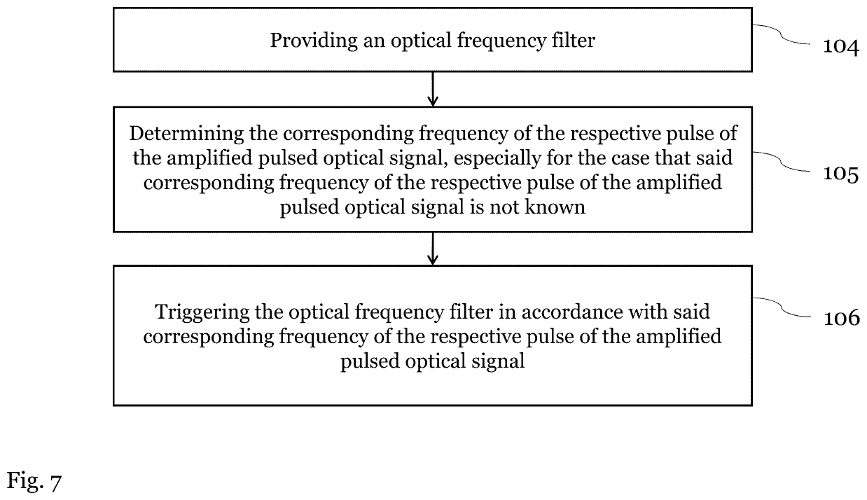

In accordance with FIG. 7, it is noted that it might be particularly advantageous if the method further comprises a step 104 comprising providing an optical frequency filter, a step 105 comprising determining the corresponding frequency of the respective pulse of the amplified pulsed optical signal, especially for the case that said corresponding frequency of the respective pulse of the amplified pulsed optical signal is not known, and a step 106 comprising triggering the optical frequency filter in accordance with said corresponding frequency of the respective pulse of the amplified pulsed optical signal.

In this context, it is noted that it might be particularly advantageous if said steps 104, 105, 106 are replaced by the step of applying an optical frequency filter, especially a glass plate with a defined spectral transmission and/or reflection, with respect to the amplified pulsed optical signal.

Again, with respect to the optical time-domain filter, it is noted that it might be particularly advantageous if the optical time-domain filter comprises or is pulsed pumping of an optical amplifier. In this context, it might be particularly advantageous if the optical amplifier comprises or is a laser amplifier. Furthermore, the optical time-domain filter may comprise or be a non-linear optical contrast enhancement.

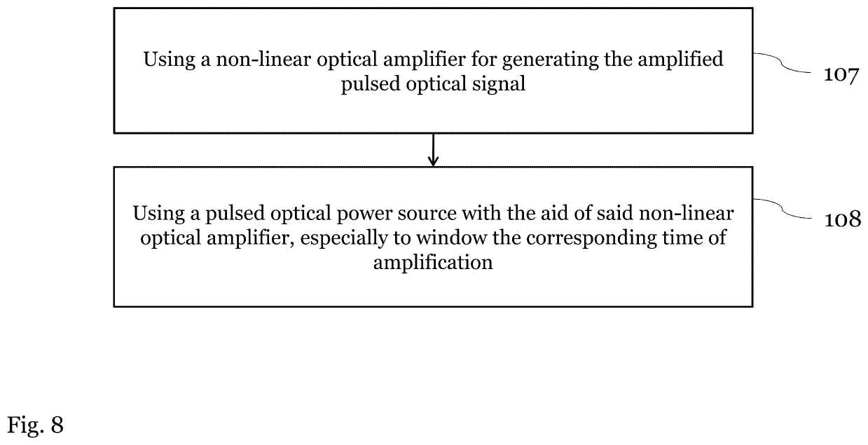

Moreover, according to FIG. 8, the method can further comprise a step 107 comprising using a non-linear optical amplifier for generating the amplified pulsed optical signal, and a step 108 comprising using a pulsed optical power source with the aid of said non-linear optical amplifier, especially to window the corresponding time of amplification. In this context, it might be particularly advantageous if the non-linear optical amplifier comprises or is an optical parametric amplifier or a Raman amplifier.

All features described above or features shown in the figures can be combined with each other in any advantageous manner within the scope of the disclosure.

1. An optical signal modifier for providing an amplified pulsed optical signal, comprising:
an optical time-domain filter arranged for filtering an optical signal amplified by an amplifier of the optical signal modifier,
wherein the optical signal modifier is configured to determine the corresponding time of the respective pulse and/or the corresponding location of the respective pulse, and
wherein the optical signal modifier is configured to trigger the optical time-domain filter in accordance with said corresponding time and/or location of the respective pulse such that any signal outside said pulse is suppressed by the optical time-domain filter.

2. The optical signal modifier according to claim 1,
wherein the optical time-domain filter comprises or is an electro-optical switch, an electro-optical switch with a trigger, an acousto-optical switch, an acousto-optical switch with a trigger, or any combination thereof.

3. The optical signal modifier according to claim 1,
wherein the optical signal modifier further comprises:
an optical frequency filter,
wherein the optical signal modifier is configured to determine the corresponding frequency of the respective pulse, especially for the case that said corresponding frequency of the respective pulse is not known, and
wherein the optical signal modifier is configured to trigger the optical frequency filter in accordance with said corresponding frequency of the respective pulse.

4. The optical signal modifier according to claim 1,
wherein the optical signal modifier further comprises:
an optical amplifier,
wherein the optical time-domain filter comprises or is pulsed pumping of said optical amplifier.

5. The optical signal modifier according to claim 4,
wherein the optical amplifier comprises or is a laser amplifier.

6. The optical signal modifier according to claim 1,
wherein the optical time-domain filter comprises or is a non-linear optical contrast enhancement.

7. The optical signal modifier according to claim 1,
wherein the optical signal modifier further comprises:
a non-linear optical amplifier,
wherein the non-linear optical amplifier is configured to use a pulsed optical power source, especially to window the corresponding time of amplification.

8. The optical signal modifier according to claim 7,
wherein the non-linear optical amplifier comprises or is an optical parametric amplifier or a Raman amplifier.

9. The optical signal modifier according to claim 1,
wherein the optical signal modifier is configured to apply cross-phase mixing, especially to reduce corresponding noise.

10. The optical signal modifier according to claim 1,
wherein the optical time-domain filter comprises or is a shutter or a mechanical shutter.

11. The optical signal modifier according to claim 1,
wherein the optical time-domain filter is triggered in accordance with the corresponding time and/or location of the respective pulse to remove unwanted background from the amplified pulsed optical signal.

12. A Lidar tester for testing a Lidar device under test or a Lidar sensor, comprising:
an optical signal modifier according to claim 1, especially configured to emit an amplified pulsed optical signal towards the Lidar device under test or towards the Lidar sensor.

13. A method for removing unwanted background from an amplified pulsed optical signal, comprising the steps of:
determining the corresponding time of the respective pulse of said amplified pulsed optical signal and/or the corresponding location of the respective pulse of said amplified pulsed optical signal,
providing an optical time-domain filter, especially arranged for filtering an optical signal amplified by an amplifier of an optical signal modifier, and
triggering the optical time-domain filter in accordance with said corresponding time and/or location of the respective pulse of said amplified pulsed optical signal such that any signal outside said pulse is suppressed by the optical time-domain filter.

14. The method according to claim 13,
wherein the optical time-domain filter comprises or is an electro-optical switch, an electro-optical switch with a trigger, an acousto-optical switch, an acousto-optical switch with a trigger, or any combination thereof.

15. The method according to claim 13,
wherein the method further comprises the steps of:
providing an optical frequency filter,
determining the corresponding frequency of the respective pulse of the amplified pulsed optical signal, especially for the case that said corresponding frequency of the respective pulse of the amplified pulsed optical signal is not known, and
triggering the optical frequency filter in accordance with said corresponding frequency of the respective pulse of the amplified pulsed optical signal.

16. The method according to claim 13,
wherein the optical time-domain filter comprises or is pulsed pumping of an optical amplifier.

17. The method according to claim 16,
wherein the optical amplifier comprises or is a laser amplifier.

18. The method according to claim 13,
wherein the optical time-domain filter comprises or is a non-linear optical contrast enhancement.

19. The method according to claim 13,
wherein the method further comprises the steps of:
using a non-linear optical amplifier for generating the amplified pulsed optical signal, and
using a pulsed optical power source with the aid of said non-linear optical amplifier, especially to window the corresponding time of amplification.

20. The method according to claim 19,
wherein the non-linear optical amplifier comprises or is an optical parametric amplifier or a Raman amplifier.
